(19) United States
(12) Patent Application Publication
(10) Pub. No.: US 2022/0099911 A1
(43) Pub. Date: Mar. 31, 2022

(54) LENS ELEMENT

(71) Applicant: GENIUS ELECTRONIC OPTICAL (XIAMEN) CO., LTD., Xiamen (CN)

(72) Inventor: Wei-Jen Lo, Xiamen (CN)

(73) Assignee: GENIUS ELECTRONIC OPTICAL (XIAMEN) CO., LTD., Xiamen (CN)

(21) Appl. No.: 17/105,634

(22) Filed: Nov. 27, 2020

(30) Foreign Application Priority Data
Sep. 30, 2020 (CN) 202011067655.2

(51) Int. Cl. G02B 7/02; G02B 3/04

(52) U.S. Cl. CPC G02B 7/022; G02B 7/028; G02B 3/04

(57) ABSTRACT

A lens element including an optical effective region and a non-optical effective region is provided. The non-optical effective region has a first surface facing an object side and a second surface facing an image side. The non-optical effective region includes a gate cutting portion connected to the first surface and the second surface, The first surface or the second surface of the non-optical effective region includes a reference surface, at least one connecting surface, and a plurality of step structures. The step structures are concavely disposed and alternate between the reference surface and the at least one connecting surface. The lens element satisfies a condition below: 4.000≤ATmax/Dpr, where ATmax is a length of an orthogonal projection of the non-optical effective region on an optical axis, and Dpr is a maximum distance between the reference surface and the step structures in a direction of the optical axis of the lens element.

### CROSS-REFERENCE TO RELATED APPLICATION

This application claims the priority benefit of Chinese application serial no. 202011067655.2, filed on Sep. 30, 2020. The entirety of the above-mentioned patent application is hereby incorporated by reference herein and made a part of this specification.

### BACKGROUND

### Technical Field

The disclosure relates to a lens element.

### Description of Related Art

Optical lens elements are indispensable basic elements in optical imaging lens or optical lens assemblies, and the quality of their own will directly affect the optical quality of optical imaging lenses or the optical lens assemblies. Therefore, for optical imaging lenses or the optical lens assemblies, how to manufacture lens elements with a stable and good quality requires continuous study.

In order to reduce the volume, the optical imaging lenses or the optical lens assemblies in the existing portable electronic devices are mostly manufactured with plastic material by injection molding technology. In injection molding, with thermal plasticity, the plastic material is first heated and melted into a molten fluid, then injected into the mold cavity of the mold through high pressure, and after cooling, taken out from the mold to obtain various special shapes that may serve various special purposes. Generally speaking, during injection molding, in the position where the diameter of the mold cavity is relatively large, the temperature is higher due to more plastic, which results in a better plastic fluidity and a faster velocity; and in the position with a smaller diameter, the temperature is lower with less plastic, which results in a slower plastic velocity.

With increasing ratios of periphery thickness to center thickness and increasing optical effective diameters of the lens element, welding lines where the molten fluid eventually converges are present in the optical effective region, which affects the optical quality of the lens element. Therefore, how to provide lens elements that have an optical effective region without a welding line, a small center thickness, and a large optical effective diameter, and how to avoid focal shift increased due to the temperature difference are issues to be addressed.

### SUMMARY

The disclosure provides a lens element, where a welding line is absent in an optical effective region, and in addition, which effectively reduces the warpage of the lens element resulting from the temperature difference.

An embodiment of the disclosure provides a lens element including an optical effective region and a non-optical effective region. The non-optical effective region surrounds the optical effective region and has a first surface facing an object side and a second surface facing an image side. The non-optical effective region includes a gate cutting portion connected to the first surface and the second surface. The first surface or second surface of the non-optical effective region includes a reference surface, at least one connecting surface, and a plurality of step structures. The reference surface is connected to the gate cutting portion. The plurality of step structures are concavely disposed and alternating between the reference surface and the at least one connecting surface. The lens element satisfies a condition below: 4.000≤ATmax/Dpr, where ATmax is a length of an orthogonal projection of the non-optical effective region on an optical axis, and Dpr is a maximum distance between the reference surface and the plurality of step structures in a direction of the optical axis of the lens element.

An embodiment of the disclosure provides a lens element including an optical effective region and a non-optical effective region. The non-optical effective region surrounds the optical effective region and has a first surface facing an object side and a second surface facing an image side. The non-optical effective region includes a gate cutting portion connected to the first surface and the second surface. The first surface or second surface of the non-optical effective region includes a reference surface, at least one connecting surface, and a plurality of step structures. The reference surface is connected to the gate cutting portion. The plurality of step structures are convexly disposed and alternating between the reference surface and the at least one connecting surface. The lens element satisfies a condition below: 4.000≤ATmax/Dpr, where ATmax is a length of an orthogonal projection of the non-optical effective region on an optical axis, and Dpr is a maximum distance between the reference surface and the plurality of step structures in a direction of the optical axis of the lens element.

An embodiment of the disclosure provides a lens element including an optical effective region and a non-optical effective region. The non-optical effective region surrounds the optical effective region and has a first surface facing an object side and a second surface facing an image side. The non-optical effective region includes a gate cutting portion connected to the first surface and the second surface. The first surface or second surface of the non-optical effective region includes a reference surface, at least one connecting surface, and a plurality of step structures. The reference surface is connected to the gate cutting portion. The plurality of step structures are concavely or convexly disposed and alternating between the reference surface and the at least one connecting surface. The lens element satisfies a condition below: 4.000≤ATmax/Dpr, where ATmax is a length of an orthogonal projection of the non-optical effective region on an optical axis, and Dpr is a maximum distance between the reference surface and the plurality of step structures in a direction of the optical axis of the lens element.

Based on the foregoing, in the lens element of the embodiment of the disclosure, since the step structures of the non-optical effective region of the lens element are concavely or convexly disposed and alternate between the reference surface and the connecting surface, and the lens element satisfies the condition of 4.000≤ATmax/Dpr therefore, not only is a welding line absent in the optical effective region, but the warpage of the lens element due to the temperature difference are effectively reduced.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A is a schematic front view of a lens element according to the first embodiment of the disclosure.

FIG. 1B is a schematic cross-sectional view of FIG. 1A.

FIG. 2 is a schematic diagram showing a turbulent flow generated when plastic flows through a step structure in a mold for forming the lens element of FIG. 1A.

FIG. 3 is a schematic diagram of plastic molding of a lens element according to the first comparative example.

FIG. 4A is a schematic diagram of a lens element according to the second comparative example.

FIG. 4B is a schematic cross-sectional view of FIG. 4A.

FIG. 5A is a schematic front view of a lens element according to the second embodiment of the disclosure.

FIG. 5B is a schematic cross-sectional view of FIG. 5A.

FIG. 6 is a schematic diagram showing a turbulent flow generated when plastic flows through a step structure in a mold for forming the lens element of FIG. 5A.

FIG. 7 is a schematic front view of a lens element according to the third embodiment of the disclosure.

FIG. 8 is a schematic diagram showing a turbulent flow generated when plastic flows through a step structure in a mold for forming the lens element of FIG. 7.

FIG. 9 is a schematic front view of a lens element according to the fourth embodiment of the disclosure.

FIG. 10 is a schematic diagram showing a turbulent flow generated when plastic flows through a step structure in a mold for forming the lens element of FIG. 9.

FIG. 11 is a schematic cross-sectional view of a lens element according to the fifth embodiment of the disclosure.

FIG. 12 shows values of important parameters of the lens element and their relations according to the first to third embodiments of the disclosure.

### DESCRIPTION OF THE EMBODIMENTS

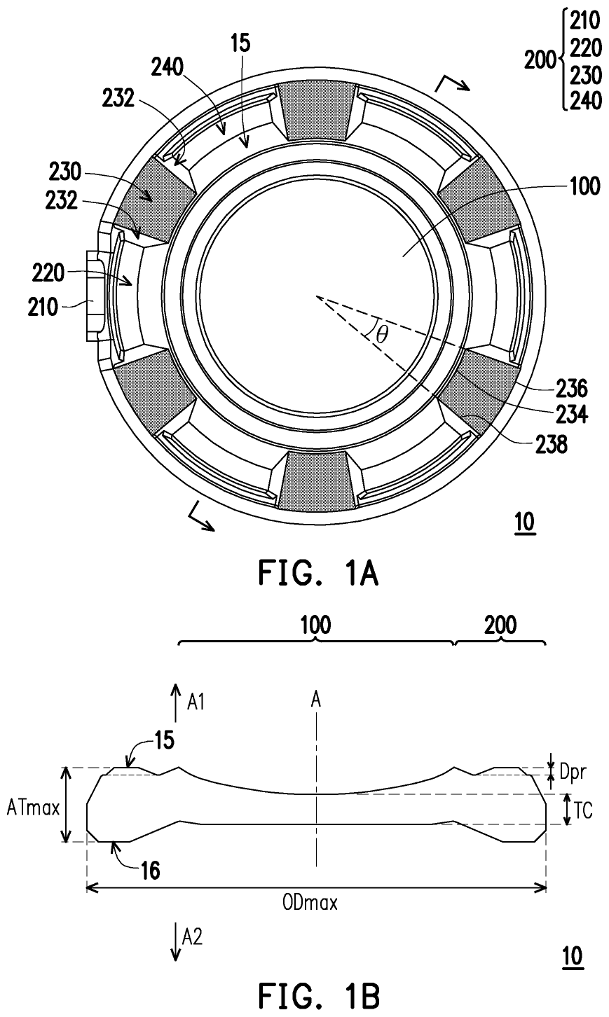

FIG. 1A is a schematic front view of a lens element according to the first embodiment of the disclosure. FIG. 1B is a schematic cross-sectional view of FIG. 1A. With reference to FIG. 1A and FIG. 1B, an embodiment of the disclosure provides a lens element 10, which includes an optical effective region 100 and a non-optical effective region 200. The non-optical effective region 200 surrounds the optical effective region 100, and has a first surface 15 facing an object side A1 and a second surface 16 facing an image side A2.

In this embodiment, the non-optical effective region 200 includes a gate cutting portion 210 connected to the first surface 15 and the second surface 16. The first surface 15 or the second surface 16 of the non-optical effective region 200 includes a reference surface 220, at least one connecting surface 240 and a plurality of step structures 230, and the lens element 10 of FIG. 1A includes five connecting surfaces 240 and six step structures 230. The connecting surface 240 and the reference surface 220 are aligned on a plane perpendicular to an optical axis A. That is to say, the surface structures not aligned with the reference surface 220 on the plane perpendicular to the optical axis A are the step structures 230.

In this embodiment, the number of the plurality of step structures 230 is an even number, which facilitates reduction of the warpage of the lens element resulting from a non-uniform internal stress of the lens element generated by thermal expansion and contraction as the temperature changes.

In this embodiment, the number of the plurality of step structures 230 is greater than or equal to 4, which facilitates designing sufficient step structures 230 to reduce the velocity of the peripheral molten fluid and avoid generating a welding line in the optical effective region.

In this embodiment, the reference surface 220 is connected to the gate cutting portion 210. That is to say, the reference surface 220 is the most adjacent surface structure to the gate cutting portion 210 among the surface structures including the reference surface 220, the connecting surface 240, and the step structures 230. The reference surface 220, the connecting surface 240, and the plurality of step structures 230 are arranged in a ring shape, and the step structures 230 are concavely disposed and alternate between the reference surface 220 and the connecting surface 240, so that the reference surface 220 or the connecting surface 240 can be designed as a supporting place of the lens element 10. When the lens element 10 is assembled in the lens, the supporting place is configured for the lens element 10 and other optical components to support each other. Herein, two of the plurality of step structures 230 are respectively connected to two opposite sides of the reference surface 220.

In this embodiment, side surfaces 232 having a draft angle respectively extend from two straight edges 238 of each step structure 230, and each draft angle is less than 75 degrees. Besides, each step structure 230 has a short arc 234, a long arc 236, and the two straight edges 238. The short arc 234 and the long arc 236 are opposite to each other, and the long arc 236 is located on a side away from the optical axis A. The two straight edges 238 are opposite to each other and connected to the short arc 234 and the long arc 236. Extension lines of the two straight edges 238 (or their orthogonal projections on the first surface 15 or the second surface 16) form an angle θ. In the lens element 10 according to the embodiment of the disclosure, the design of a draft angle less than 75 degrees facilitates an increase in the yield rate of the lens element 10 during the mold release; the design that the step structures 230 have the short arc 234, the long arc 236, and the straight edges 238, and that the extension lines of the straight edges 238 form an angle θ facilitates an increase in the structural strength of the non-optical effective region 200 of the lens element 10 for lens assembly work, and avoid the warpage of the lens element and focal shift increased due to the temperature difference.

In this embodiment, a ratio of a sum of central angles of the supporting places of the lens element 10 relative to the optical axis A to a sum of central angles of non-supporting places of the lens element 10 relative to the optical axis A is greater than or equal to 1.000, which facilitates an increase the structural strength of the lens element 10, avoids a decrease in the assembly yield rate, and reduces the warpage of the lens element resulting from a non-uniform internal stress of the lens element generated by thermal expansion and contraction.

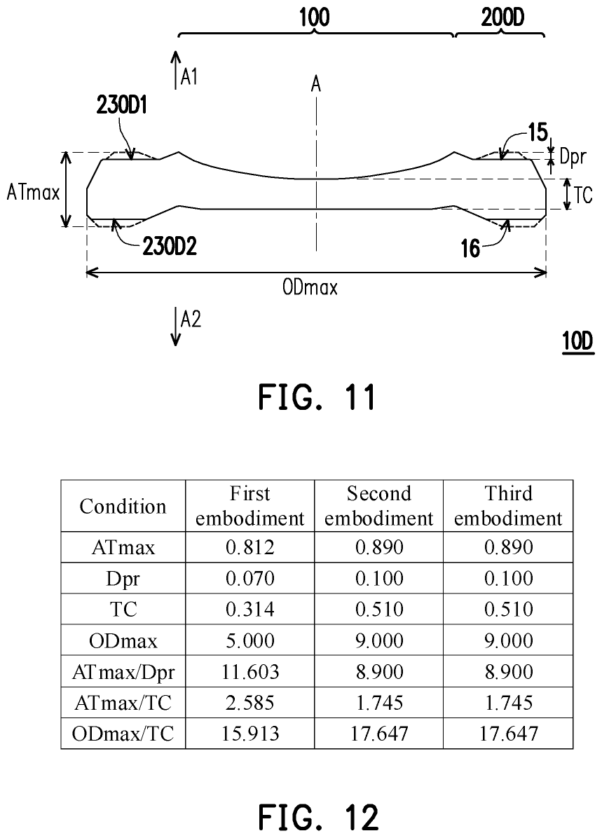

In this embodiment, the reference surface 220, the connecting surface 240, and the plurality of step structures 230 are all disposed on the first surface 15, which facilitates the design of a fitting structure with other lens elements, improves the assembly of the lens element, and reduces the possibility of eccentricity. However, the disclosure is not limited thereto. The reference surface, the connecting surface, and the step structures may as well be all disposed on the second surface 16. Alternatively, the reference surface, the connecting surface, and the step structures may be disposed on both the first surface 15 and the second surface 16, (as shown in FIG. 11).

Besides, detailed optical data of the lens element 10 according to the first embodiment is as shown in FIG. 12.

In this embodiment, when the lens element 10 satisfies a condition below: ATmax/TC≤3.000, it helps to prevent a welding line in the optical effective region during the manufacturing process resulting from a maximum thickness of the non-optical effective region 200 of the lens element 10 being too large or a center thickness of the lens element being too small. Herein, ATmax is a length of an orthogonal projection of the non-optical effective region 200 on the optical axis A, and TC is a thickness of the lens element 10 on the optical axis A.

In this embodiment, when the lens element 10 satisfies a condition below: ODmax/TC≤20.000, it helps to prevent a welding line in the optical effective region 100 resulting from an outer diameter of the lens element being too large or the center thickness of the lens element being too small. Herein, ODmax is a maximum outer diameter of the lens element 10.

In this embodiment, surface roughnesses of the reference surface 220, the connecting surface 240, and the plurality of step structures 230 are greater than a surface roughness of the optical effective region 100, which facilitates reduction in stray light of the lens element 10.

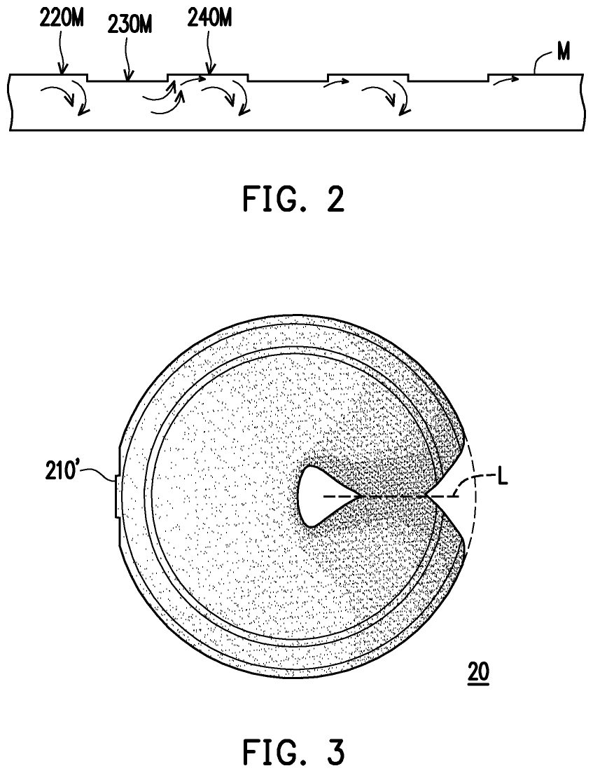

FIG. 2 is a schematic diagram showing a turbulent flow generated when plastic flows through a step structure in a mold for forming the lens element of FIG. 1A. In FIG. 2, a mold M includes a reference surface 220M, a step structure 230M, and a connecting surface 240M respectively corresponding to the reference surface 220, the step structure 230, and the connecting surface 240 of the lens element 10. In addition, the lens element 10 formed by the mold M satisfies condition (1): 4.000≤ATmax/Dpr, where a preferred range is 4.000≤ATmax/Dpr≤20.000. Dpr is a maximum distance between the reference surface 220 and the step structure 230 in a direction of the optical axis A of the lens element 10. With reference to FIG. 2, when plastic flows through the step structure 230M, a turbulent flow of the plastic is generated at the step structure 230M, which effectively reduces the velocity of the molten plastic fluid. Moreover, in the lens element 10 according to an embodiment of the disclosure, not only is the lens element 10 facilitated to have an optical effective region without a welding line, a small center thickness, and a large optical effective diameter since the lens element 10 satisfies the above-mentioned condition (1), and the step structures 230 are concavely disposed and alternate between the reference surface 220 and the connecting surface 240, but the warpage of the lens element and focal shift increased due to the temperature difference are also reduced through controlling the ratio of ATmax to Dpr and preventing the same from being too small.

FIG. 3 is a schematic diagram of plastic molding of a lens element according to the first comparative example. With reference to FIG. 3, the main difference between a lens element 20 of FIG. 3 and the lens element 10 of FIG. 1A is that the lens element 20 does not have the step structure 230 of the lens element 10. In FIG. 3, the plastic is injected from a gate cutting portion 210′. The plastic converges on a side of the lens element 20 opposite to the gate cutting portion 210′ and forms a welding line L at a place where the velocity is slower. In the lens element 20, when a ratio of the periphery thickness to the center thickness increases and an optical effective diameter increases, the welding line L tends to form in an optical effective region of the lens element 20, thus affecting the optical quality of the lens element 20.

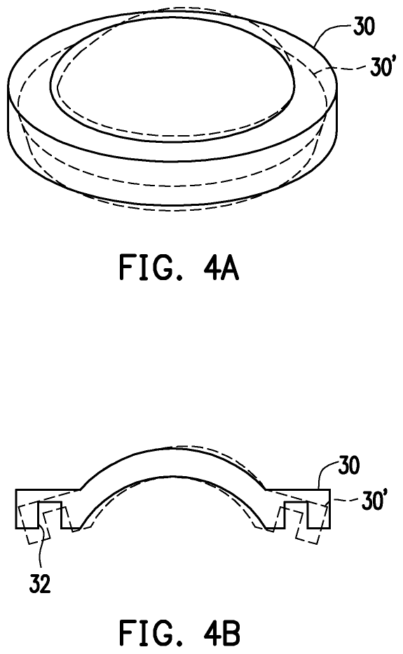

FIG. 4A is a schematic diagram of a lens element according to the second comparative example. FIG. 4B is a schematic cross-sectional view of FIG. 4A. In FIG. 4A and FIG. 4B, a lens element 30′ has a shape changed after a lens element 30 undergoes different temperature changes. With reference to FIG. 4A and FIG. 4B, the main difference between the lens element 30 of FIG. 4A or FIG. 4B and the lens element 20 of FIG. 3 is that in the lens element 30, a plurality of grooves 32 are disposed in the non-optical effective region, which reduces the velocity of the molten fluid, so that the welding line where the molten fluid eventually converges is present in the non-optical effective region. However, the groove 32 when being too deep in structure leads to a relatively large thickness difference between different regions of the non-optical effective region, intensifying non-uniformity of the internal stress of the lens element 30 due to thermal expansion and contraction as the temperature changes and causing warpage of the lens element 30′. Thereby, the focal shift resulting from the temperature difference greatly increases in magnitude in the optical imaging lens or the optical lens assembly, affecting the optical quality. On the contrary, when the groove 32 is too shallow, the velocity of the molten plastic fluid cannot be effectively reduced, so that a part of the welding lines is still present in the optical effective region, thereby affecting the optical quality. Therefore, by controlling the ratio of ATmax to Dpr to be greater than or equal to 4.000 or fall within a range of 4.000 to 20.000, not only is the welding line formed in a position in the non-optical effective region of the lens element 10, but thickness at each position of the lens element 10 also matches the thickness of lens element as originally designed.

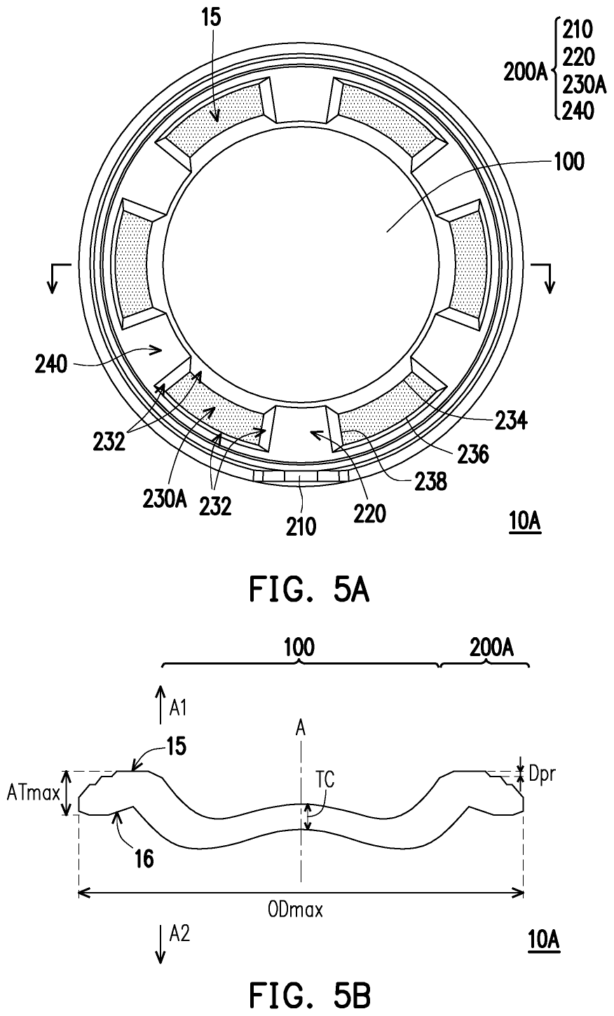

FIG. 5A is a schematic front view of a lens element according to the second embodiment of the disclosure. FIG. 5B is a schematic cross-sectional view of FIG. 5A. With reference to FIG. 5A and FIG. 5B, a lens element 10A of FIG. 5A is similar to the lens element 10 of FIG. 1A. The main difference is that in a non-optical effective region 200A, step structures 230A are convexly disposed and alternate between the reference surface 220 and the connecting surface 240. In addition, side surfaces 232 having a draft angle respectively extend from the two straight edges 238, the short arc 234, and the long arc 236 of each step structure 230A. In this embodiment, the step structures 230A are supporting places of the lens element 10A.

Besides, detailed optical data of the lens element 10A according to the second embodiment is as shown in FIG. 12.

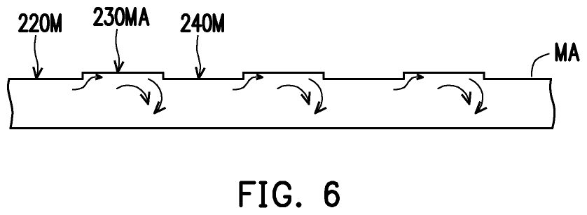

FIG. 6 is a schematic diagram showing a turbulent flow generated when plastic flows through a step structure in a mold for forming the lens element of FIG. 5A. In FIG. 6, a mold MA includes the reference surface 220M, a step structure 230MA, and the connecting surface 240M respectively corresponding to the reference surface 220, the step structure 230, and the connecting surface 240 of the lens element 10A, and the lens element 10A formed by the mold MA satisfies condition (1). With reference to FIG. 6, when plastic flows through the step structure 230MA, a turbulent flow of the plastic is generated at the step structure 230MA, which effectively reduces the velocity of the molten plastic fluid. Moreover, according to an embodiment of the disclosure, since the lens element 10A satisfies the above-mentioned condition (1), and the step structures 230A are convexly disposed and alternate between the reference surface 220 and the connecting surface 240, the lens element 10A is facilitated to have an optical effective region without a welding line, a small center thickness, and a large optical effective diameter. In addition, in the lens element 10A, the convex step structures 230A also facilitate an increase in the structural strength, enhance the stability of lens assembly work, and reduce the warpage of the lens element and focal shift increased due to the temperature difference.

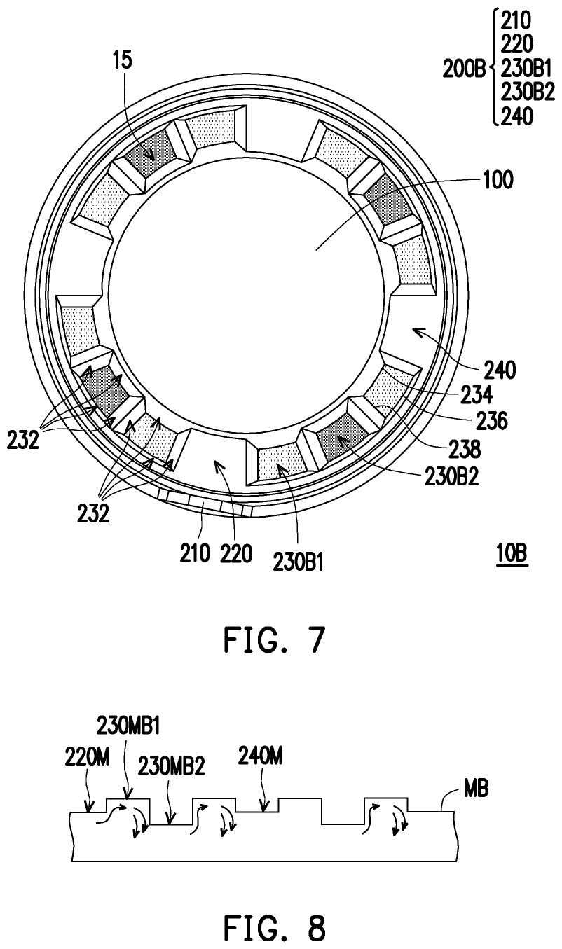

FIG. 7 is a schematic front view of a lens element according to the third embodiment of the disclosure. With reference to FIG. 7, a lens element 10B of FIG. 7 is similar to the lens element 10 of FIG. 1A. The main difference is that in a non-optical effective region 200B, step structures 230B1 and 230B2 are concavely or convexly disposed and alternate between the reference surface 220 and the connecting surface 240. In FIG. 7, the step structure 230B1 is a convex surface structure relative to the reference surface 220, and the step structure 230B2 is a concave surface structure relative to the reference surface 220. In addition, side surfaces 232 having a draft angle respectively extend from the two straight edges 238, the short arc 234, and the long arc 236 of each of the step structures 230B1 and 230B2. In this embodiment, a part of the step structures are supporting places of the lens element 10B. In FIG. 7, the step structures 230B1 are the supporting places of the lens element 10B.

In addition, detailed optical data of the lens element 10B according to the third embodiment is as shown in FIG. 12.

FIG. 8 is a schematic diagram showing a turbulent flow generated when plastic flows through a step structure in a mold for forming the lens element of FIG. 7. In FIG. 8, a mold MB includes the reference surface 220M, step structures 230MB1, 230MB2, and the connecting surface 240M respectively corresponding to the reference surface 220, the step structures 230B1 and 230B2, and the connecting surface 240 of the lens element 10B, and the lens element 10B formed by the mold MB satisfies condition (1). With reference to FIG. 8, when plastic flows through the step structure 230MB1 or the step structure 230MB2, a turbulent flow of the plastic is generated at the step structure 230MB1 or the step structure 230MB2, which effectively reduces the velocity of the molten plastic fluid. Moreover, in the lens element 10B according to an embodiment of the disclosure, the lens element 10B satisfies the above-mentioned condition (1), and continuous deceleration of the molten fluid is achieved and fluidity is better spoiled through the convex and concave step structures 230B1 and 230B2, which therefore is applicable to a lens element that has a large optical effective diameter or a large ratio of the periphery thickness to the center thickness and an optical effective region without a welding line, and reduces the warpage of the lens element and focal shift increased due to the temperature difference.

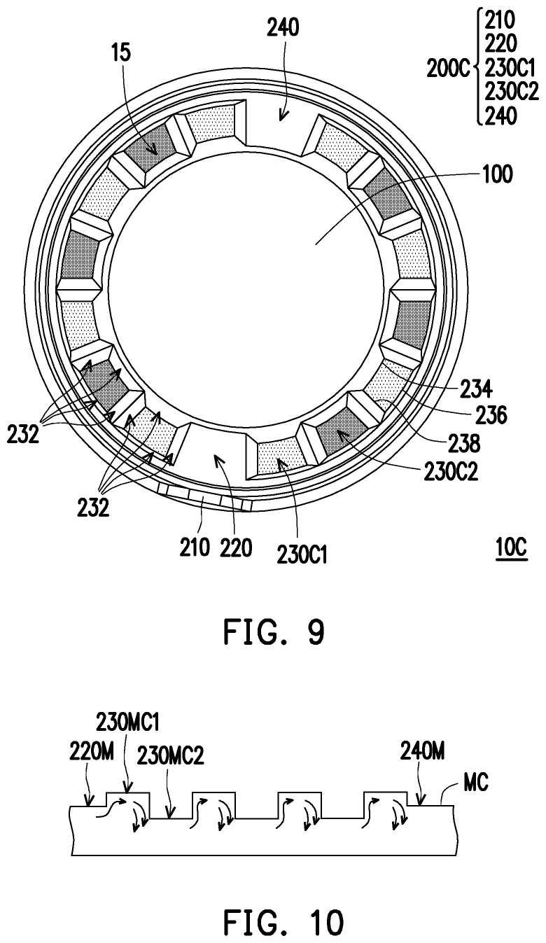

FIG. 9 is a schematic front view of a lens element according to the fourth embodiment of the disclosure. With reference to FIG. 9, a lens element 10C of FIG. 9 is similar to the lens element 10B of FIG. 7. In a non-optical effective region 200C, step structures 230C1 and 230C2 are concavely or convexly disposed and alternate between the reference surface 220 and the connecting surface 240. In FIG. 9, the step structure 230C1 is a convex surface structure relative to the reference surface 220, and the step structure 230C2 is a concave surface structure relative to the reference surface 220. In FIG. 9, the step structures 230C1 are the supporting places of the lens element 10C.

Besides, detailed optical data of the lens element 10C according to the fourth embodiment is the same as the lens element 10B according to the third embodiment.

FIG. 10 is a schematic diagram showing a turbulent flow generated when plastic flows through a step structure in a mold for forming the lens element of FIG. 9. In FIG. 10, a mold MC includes the reference surface 220M, step structures 230MC1, 230MC2, and the connecting surface 240M respectively corresponding to the reference surface 220, the step structures 230C1 and 230C2, and the connecting surface 240 of the lens element 10C, and the lens element 10C formed by the mold MC satisfies condition (1). The main difference is that there is only one connecting surface 240, which therefore best spoils the flow, is applicable to a lens element that is relative large or has a relatively large ratio of the periphery thickness to the center thickness and does not have a welding line in the optical effective region, and reduces the warpage of the lens element and focal shift increased due to the temperature difference.

FIG. 11 is a schematic cross-sectional view of a lens element according to the fifth embodiment of the disclosure. With reference to FIG. 11, a lens element 10D of FIG. 11 is similar to the lens element 10 of FIG. 1A. The main difference is that a step structure 230D1 of a non-optical effective region 200D of the lens element 10D is disposed on the first surface 15, but a step structure 230D2 is disposed on the second surface 16, where the step structures 230D1 and 230D2 are both concave surface structures relative to the reference surface. However, the disclosure is not limited thereto. In an embodiment, the step structures 230D1 and 230D2 may be convex surface structures similar to the step structures 230A according to the second embodiment. In another embodiment, the step structures 230D1 and 230D2 may also be concave or convex surface structures similar to the step structures 230B1 and 230B2 according to the third embodiment.

In summary of the foregoing, the lens element according to the embodiment of the disclosure achieves the following:

1. In the lens element, the step structures of the non-optical effective region are concavely disposed and alternate between the reference surface and the connecting surface, and the lens element satisfies the condition below: 4.000≤ATmax/Dpr, which facilitates manufacturing the lens element that has an optical effective region without a welding line, a small thickness, and a large optical effective diameter, and reduces the warpage of the lens element and the focal shift increased due to the temperature difference.

2. In the lens element, the step structures of the non-optical effective region are convexly disposed and alternate between the reference surface and the connecting surface, and the lens element satisfies the condition below: 4.000≤ATmax/Dpr, which facilitates manufacturing the lens element that has an optical effective region without a welding line, a small center thickness, and a large optical effective diameter. In addition, the convex step structures also facilitate an increase in the structural strength, enhance the stability of lens assembly work, and reduce the warpage of the lens element and the focal shift increased due to the temperature difference.

3. In the lens element, the step structures of the non-optical effective region are concavely or convexly disposed and alternate between the reference surface and the connecting surface, and the lens element satisfies the condition below: 4.000≤ATmax/Dpr, which achieves continuous deceleration of the molten fluid and better spoils the flow through the convex and concave step structures, facilitates manufacturing the lens element that has a large effective diameter or a relatively large ratio of the periphery thickness to the center thickness without generating a welding line in the optical effective region, and reduces the warpage of the lens element and focal shift increased due to the temperature difference.

The numeral range containing the maximum and minimum values obtained from the combining proportional relationship of the optical parameter disclosed in each embodiment of the disclosure is able to be carried out.

Although the disclosure has been disclosed in the above embodiments, the embodiments are not intended to limit the disclosure. It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A lens element, comprising:
an optical effective region; and
a non-optical effective region surrounding the optical effective region and having a first surface facing an object side and a second surface facing an image side, wherein the non-optical effective region comprises:
a gate cutting portion connected to the first surface and the second surface, wherein the first surface or the second surface of the non-optical effective region comprises:
a reference surface connected to the gate cutting portion;
at least one connecting surface; and
a plurality of step structures concavely disposed and alternating between the reference surface and the at least one connecting surface; and
the lens element satisfies a condition below: 4.000≤ATmax/Dpr, wherein ATmax is a length of an orthogonal projection of the non-optical effective region on an optical axis, and Dpr is a maximum distance between the reference surface and the plurality of step structures in a direction of the optical axis of the lens element.

2. The lens element according to claim 1, wherein the reference surface or the at least one connecting surface is a supporting place of the lens element.

3. The lens element according to claim 1, wherein the lens element further satisfies a condition below: ATmax/TC≤3.000, wherein TC is a thickness of the lens element on the optical axis.

4. A lens element, comprising:
an optical effective region; and
a non-optical effective region surrounding the optical effective region and having a first surface facing an object side and a second surface facing an image side, wherein the non-optical effective region comprises:
a gate cutting portion connected to the first surface and the second surface, wherein the first surface or the second surface of the non-optical effective region comprises:
a reference surface connected to the gate cutting portion;
at least one connecting surface; and
a plurality of step structures convexly disposed and alternating between the reference surface and the at least one connecting surface; and
the lens element satisfies a condition below: 4.000≤ATmax/Dpr, wherein ATmax is a length of an orthogonal projection of the non-optical effective region on an optical axis, and Dpr is a maximum distance between the reference surface and the plurality of step structures in a direction of the optical axis of the lens element.

5. The lens element according to claim 4, wherein the plurality of step structures are supporting places of the lens element.

6. The lens element according to claim 4, wherein the lens element further satisfies a condition below: ATmax/TC≤3.000, wherein TC is a thickness of the lens element on the optical axis.

7. A lens element, comprising:
an optical effective region; and
a non-optical effective region surrounding the optical effective region and having a first surface facing an object side and a second surface facing an image side, wherein the non-optical effective region comprises:
a gate cutting portion connected to the first surface and the second surface, wherein the first surface or the second surface of the non-optical effective region comprises:
a reference surface connected to the gate cutting portion;
at least one connecting surface; and
a plurality of step structures concavely or convexly disposed and alternating between the reference surface and the at least one connecting surface; and
the lens element satisfies a condition below: 4.000≤ATmax/Dpr, wherein ATmax is a length of an orthogonal projection of the non-optical effective region on an optical axis, and Dpr is a maximum distance between the reference surface and the plurality of step structures in a direction of the optical axis of the lens element.

8. The lens element according to claim 7, wherein a part of the plurality of step structures are supporting places of the lens element.

9. The lens element according to claim 7, wherein two of the plurality of step structures are respectively connected to two opposite sides of the reference surface.

10. The lens element according to claim 7, wherein the at least one connecting surface and the reference surface are aligned on a plane perpendicular to the optical axis.

11. The lens element according to claim 7, wherein the reference surface, the at least one connecting surface, and the plurality of step structures are arranged in a ring shape.

12. The lens element according to claim 7, wherein a ratio of a sum of central angles of supporting places of the lens element relative to the optical axis to a sum of central angles of non-supporting places of the lens element relative to the optical axis is greater than or equal to 1.000.

13. The lens element according to claim 7, wherein each step structure has a short arc, a long arc, and two straight edges, the short arc and the long arc are opposite to each other, the long arc is located on a side away from the optical axis, the two straight edges are opposite to each other and connected to the short arc and the long arc, and extension lines of the two straight edges form an angle.

14. The lens element according to claim 7, wherein the number of the plurality of step structures is an even number.

15. The lens element according to claim 7, wherein the number of the plurality of step structures is greater than or equal to 4.

16. The lens element according to claim 7, wherein side surfaces having a draft angle respectively extend from two straight edges of each step structure, and each draft angle is less than 75 degrees.

17. The lens element according to claim 7, wherein the lens element further satisfies a condition below: ATmax/TC≤3.000, wherein TC is a thickness of the lens element on the optical axis.

18. The lens element according to claim 7, wherein the lens element further satisfies a condition below: ODmax/TC≤20.000, wherein ODmax is a maximum outer diameter of the lens element, and TC is a thickness of the lens element on the optical axis.

19. The lens element according to claim 7, wherein surface roughnesses of the reference surface, the at least one connecting surface, and the plurality of step structures are greater than a surface roughness of the optical effective region.

20. The lens element according to claim 7, wherein the reference surface, the at least one connecting surface, and the plurality of step structures are disposed on the first surface.
